(19) United States
(12) Patent Application Publication
(10) Pub. No.: US 2010/0294870 A1
(43) Pub. Date: Nov. 25, 2010

(54) Paper Shredder Blade with a Reinforced Structure

(75) Inventor: HUIZE WANG, Dongguan (CN)

Correspondence Address: GLOBAL IP SERVICES, 7285 W. Eagle Court, Winton, CA, 95388, US

(73) Assignee: DONGGUAN TIEZHI ELECTRONIC CO., LTD.

(21) Appl. No.: 12/766,879

(22) Filed: Apr. 24, 2010

(30) Foreign Application Priority Data
May 19, 2009 (CN) 200920056810.3

(51) Int. Cl. B02C 18/00

(52) U.S. Cl. 241/291

(57) ABSTRACT

The invention relates to the technical field of paper shredder, in particular to a paper shredder blade with a reinforced structure, which comprises a cutter body in the shape of a sheet, a mounting hole is arranged on the cutter body, a bent cutter tip is shaped on the cutter body, and a cutter tip reinforcing part is shaped on the cutter tip; the invention can improve the non-deformability of the cutter tip by using the bent cutter tip and shaping the cutter tip reinforcing part on the cutter tip so as to shred relatively thick paper or a plurality of papers, thereby saving the production cost greatly.

### CROSS REFERENCE TO RELATED PATENT APPLICATION

The present application claims the priority of the Chinese patent application No. 200920056810.3 filed on May 19, 2009, which application is incorporated herein by reference.

### FIELD OF THE INVENTION

The invention relates to the technical field of paper shredder, in particular to a paper shredder blade with a reinforced structure.

### BACKGROUND OF THE INVENTION

Along with the rapid development of science & technology, more human-oriented products with new functions have moved into our life and work, the paper shredder is one of which. The paper shredder can help people to shred the important file into small paper particles with a fast speed; one of the main work parts of the paper shredder is the blade. The paper shredder has multiple groups of blades, each group consists of a pair of blades, multiple groups of blades are fixed to the same connecting shaft, the blades will be drove to rotate when the connecting shaft rotates, therefore the cutter tip of the blade will shred the paper, simultaneously, the contact between the cutter tip and the paper when the blades rotate also drive the paper to move into the paper shredder. In order to make the paper shredder shred relatively thick paper once or a plurality of papers simultaneously, the acting force of the blade needs to increase, the general practice is to increase the thickness of the blade, however, this solution is unfavorable to the manufacture as it will increase the production cost, therefore, it is necessary to design a blade which can meet the requirements of practical application while the production cost is not increased.

### SUMMARY OF THE INVENTION

Aiming at the shortages of the prior technology, the invention provides a paper shredder with a reinforced structure, which has a certain non-deformability and reaches the use effect of the thick blade, moreover, the invention will not increase the production cost.

In order to realize the purpose, the invention uses following technical proposal:

The paper shredder blade with a reinforced structure comprises a cutter body in the shape of a sheet, a mounting hole is arranged on the cutter body, a bent cutter tip is shaped on the cutter body, and a cutter tip reinforcing part is shaped on the cutter tip.

A cutter body reinforcing rib is formed on the cutter body.

The cutter tip reinforcing part is shaped by direct impact molding, one side of which is convex relative to the surface of the cutter body; the other side is concave relative to the surface of the cutter body.

The cutter body reinforcing part is shaped by direct impact molding, which is concave along one side of the cutter body as well as convex relative to the other side of the cutter body.

The amount of the cutter body reinforcing part is a plurality, the plurality of cutter body reinforcing parts are evenly distributed on the cutter body.

The cutter tip reinforcing part and cutter body reinforcing parts are connected as a body via a reinforcing rib.

The reinforcing rib is shaped by direct impact molding, which is concave along one side of the cutter body as well as convex relative to the other side of the cutter body.

The invention has beneficial effects of increasing the non-deformability of the cutter tip by using the bent cutter tip and forming the cutter tip reinforcing part on the cutter tip, thereby reaching the effect of shredding relatively thick or a plurality of papers smoothly, which greatly saves the production cost.

### BRIEF DESCRIPTION OF THE DRAWINGS

FIG. 1 is the structure diagram of the invention;

FIG. 2 is the upward view of the invention;

FIG. 3 is the assembly diagram of the invention.

### DETAILED DESCRIPTION OF THE INVENTION

Combining with the attached drawings, further descriptions for the invention are stated following:

Following statement is the better embodiment of the invention only, however, the scope of protection of the invention is not defined by it.

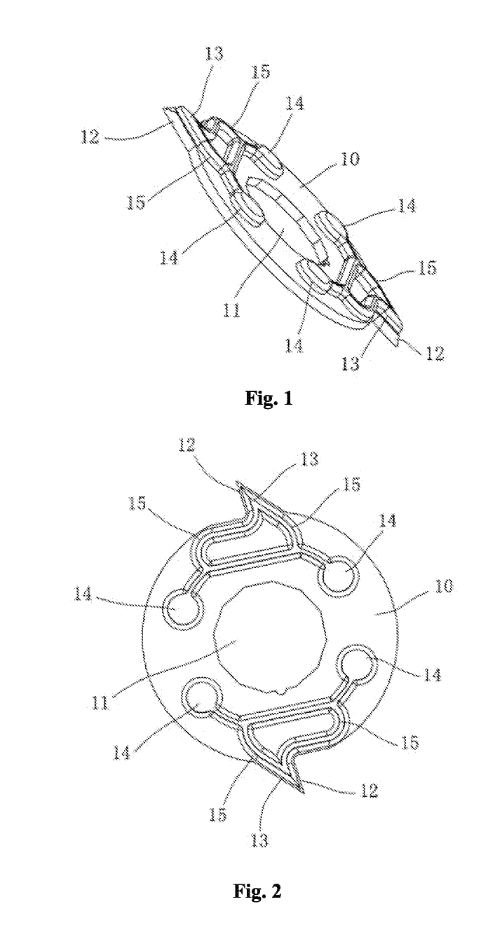

As shown in attached drawing FIGS. 1, 2, the invention comprises a cutter body 10 in the shape of a sheet, the cutter body 10 is circular usually, the cutter body 10 is provided with a polygonal mounting hole 11 thereon, the mounting hole is arranged at the central position of the cutter body 10 usually and used for passing through the connecting shaft; a bent cutter tip 12 is shaped on the cutter body 10, the cutter tip 12 is located on the same plane with the cutter body 10, the lateral part of the cutter body is outwards extended to form the cutter tip 12 when process the blade, and the cutter tip 12 is bended almost 90 degrees, such that the acting force of the cutter tip 12 when shred papers is coincident with that of the cutter body 10, thereby increasing the effect of shredding papers by using the cutter body 10, further, a cutter tip reinforcing part 13 is formed on the cutter tip 12, thereby increasing the non-deformability of the cutter tip by using the cutter tip reinforcing part 13.

The cutter tip reinforcing part 13 is shaped by direct stamping and in the shape of bulge; the cutter tip reinforcing part 13 can be integrally formed when shape the blade, the shape of the cutter tip reinforcing part 13 should be in coincident with the cutter tip. One side of the cutter tip reinforcing part 13 is concave along the cutter body 10 and convex above the other side of the cutter body 10, thereby reaching the purpose of increasing the non-deformability of the cutter tip 12 so as to the shred relatively thick or a plurality of papers simultaneously; further more, as shown in FIG. 2, the cutter tip reinforcing part 13 can reach the effect of conflicting with adjacent blade to form a certain gap when two blades are combined together.

A cutter body reinforcing part 14 is shaped on the cutter body 10; the amount of the cutter body reinforcing parts is a plurality, the plurality of the cutter body reinforcing parts 14 are evenly distributed on the cutter body 10.

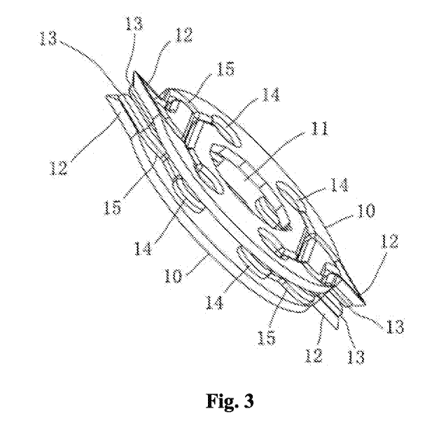

The cutter body reinforcing part 14 is shaped by using direct stamping manner, and the cutter body reinforcing part is concave along one side of the cutter body 10 and convex above the other side of the cutter body. The cutter body reinforcing part 14 can be integrally formed when shape the blade, the shape of which is not defined, moreover, the cutter body reinforcing part 14 can reach the effect of increasing the non-deformability of the cutter body, simultaneously, as shown in FIG. 3, the cutter body reinforcing part 14 also can reach the effect of conflicting with adjacent blade to form a certain gap when two blades are combined together.

The cutter tip reinforcing part 13 and the cutter body reinforcing part 14 are connected as a body via reinforcing rib 15; the reinforcing rib 15 is concave along one side of the cutter body 10 and convex above the other side of the cutter body 10. By using the structure, the effect of using the reinforcing rib 15 to strengthen the cutter body can be reached, and the cutter tip reinforcing part 13 and the cutter body reinforcing part 14 are connected together, thereby greatly increasing the non-deformability.

By using the bent cutter tip and the reinforcing part, the invention can reach the use effect of using thick blade, and have simple structure as well as save production cost.

What is claimed is:

1. A paper shredder blade with a reinforced structure, comprising a cutter body (10) in a shape of sheet, a mounting hole (11) is arranged on the cutter body (10), wherein a bent cutter tip (12) is shaped on the cutter body (10), and a cutter tip reinforcing part (13) is shaped on the cutter tip (12).

2. The paper shredder blade with a reinforced structure according to claim 1, wherein a cutter body reinforcing part (14) is formed on the cutter body (10).

3. The paper shredder blade with a reinforced structure according to claim 2, wherein one side of the cutter tip reinforcing part (13) is convex relative to a surface of the cutter body (10), other side of the cutter tip reinforcing part (13) is concave relative to other surface of the cutter body (10).

4. The paper shredder blade with a reinforced structure according to claim 2, wherein the cutter body reinforcing part (14) is concave relative to one side of the cutter body (10) as well as is convex relative to other side of the cutter body (10).

5. The paper shredder blade with a reinforced structure according to claim 4, wherein there are a plurality of cutter body reinforcing parts evenly distributed on the cutter body (10).

6. The paper shredder blade with a reinforced structure according to claim 4, wherein the cutter tip reinforcing part (13) and cutter body reinforcing parts (14) are connected as an integrative body via a reinforcing rib (15).

7. The paper shredder blade with a reinforced structure according to claim 6, wherein the reinforcing rib (15) is concave relative to one side of the cutter body (10) as well as is convex relative to other side of the cutter body (10).

8. The paper shredder blade with a reinforced structure according to claim 3, wherein the cutter body reinforcing part (14) is concave relative to one side of the cutter body (10) as well as is convex relative to other side of the cutter body (10).

9. The paper shredder blade with a reinforced structure according to claim 8, wherein there are a plurality of cutter body reinforcing parts evenly distributed on the cutter body (10).

10. The paper shredder blade with a reinforced structure according to claim 8, wherein the cutter tip reinforcing part (13) and cutter body reinforcing parts (14) are connected as an integrative body via a reinforcing rib (15).

11. The paper shredder blade with a reinforced structure according to claim 8, wherein the reinforcing rib (15) is concave relative to one side of the cutter body (10) as well as is convex relative to other side of the cutter body (10).
